(19) United States
(12) Patent Application Publication
(10) Pub. No.: US 2015/0201584 A1
(43) Pub. Date: Jul. 23, 2015

(54) PET AMUSEMENT DEVICE

(71) Applicant: The Kong Company, LLC, Golden, CO (US)

(72) Inventor: Sabine S. Crane, San Clemente, CA (US)

(21) Appl. No.: 14/159,668

(22) Filed: Jan. 21, 2014

(51) Int. Cl. A01K 15/02

(52) U.S. Cl. CPC A01K 15/025

(57) ABSTRACT

A pet amusement device provides a moving play object within a cage structure with apertures that provide intermittent visual and tactile interaction of the pet with the play object. The motion of the play object is unpredictable and visually interesting to the pet. Motion of the play object may be caused by a play object driving assembly, which exerts magnetic forces on the pay object and causes it to move on a gliding surface of a floor member within the cage structure in an unpredictable manner. The magnetic forces may be provided by a rotating carriage member driven by a motor and gear assembly beneath the gliding surface. The play object may also be provided with a magnetic element, such that the carnage member magnets exert repulsive forces on the play object as the carriage member rotates. A spacing disk on the play object may maintain the play object magnet a predetermined distance above the gliding surface.

### BACKGROUND

1. Technical Field

The disclosure relates to pet toys and amusement devices.

2. Prior Art

Toys and devices that provide amusement to pets are generally known. They may include stuffed animals, chew toys, or more sophisticated motorized devices. Ali are intended to keep pets occupied, exercised, and to provide entertainment to human owners as they observe their pets interacting with such devices. One challenge in the art is to provide pet amusement devices that sustain the pet's interest and that provide motion that is visually interesting and unpredictable, and simulates the motion and interaction of the pet with a living prey animal. Another challenge with mechanical amusement devices is to provide for pet safety as pets interact with such devices.

There is thus a need in the art for pet amusement devices that address the aforementioned problems in the prior art. The subject matter of the present disclosure is directed to overcoming, or at least reducing the effects of, one or more of the problems or needs set forth above, and others.

### SUMMARY OF THE INVENTION

According to an aspect of the invention, a pet amusement device provides a moving play object that is driven by a magnetic play object driving assembly. The play object may be disposed within a housing, including a cover member that is formed as a dome-shaped cage structure, which may be provided with a number of apertures of varying shapes, provides intermittent visual and tactile interaction by the pet as the play object moves within an interior space of the housing. The magnetic driving assembly causes the play object to move in an unpredictable manner and without a direct mechanical coupling, thus providing additional safety to the pet. The play object driving assembly may include a rotating carnage member driven by an electric motor and gearing, and provided with one or more magnets and disposed beneath a gliding surface, which supports the play object. The play object may also be provided with a magnetic element, such that the carriage member magnets exert repulsive forces on the play object and move it on the gliding surface in within the housing interior space.

### BRIEF DESCRIPTION OF THE DRAWINGS

The above and other attendant advantages and features of the invention will be apparent from the following detailed description together with the accompanying drawings, in which like reference numerals represent like elements throughout, It will be understood that the description and embodiments are intended as illustrative examples and are not intended to be limiting to the scope of invention, which is set forth in the claims appended hereto.

FIG. 1 is an oblique view showing an assembled pet amusement device according to an aspect of the invention.

FIG. 2 is top view of a pet amusement device according to an aspect of the invention.

FIG. 3 is an exploded vie of a pet amusement device according to an aspect of the invention.

FIG. 4 is an exploded detailed view of a motion-creating assembly according to an aspect of the invention.

FIG. 5 is an exploded view of a play object according to an aspect of the invention.

### DETAILED DESCRIPTION

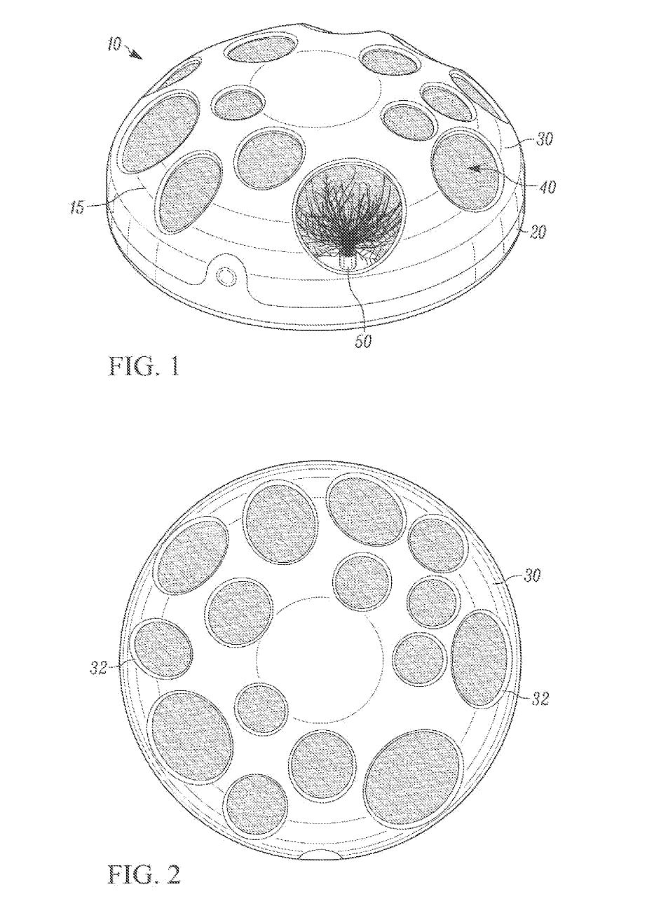

FIG. 1 illustrates an oblique view of an assembled pet amusement device according to an aspect of the invention. The pet amusement device 10, generally may include a housing 15 that may be formed by a base member 20 and a top cover 30 to define and interior space 40. According to an aspect of the invention, a moving play object 50 may be disposed within the interior space 40.

Referring additionally to FIG. 2, top cover 30 may be formed in a generally dome-shape, with a plurality of apertures 32, formed therein, to provide a cage structure. Although illustrated as oval- or elliptical-shaped, apertures 32 may be of any shape and size. Apertures 32 provide for a view to the interior space 40 and allow intermittent viewing and tactile interaction by the pet with the loving play object 50 (not shown in FIG. 2).

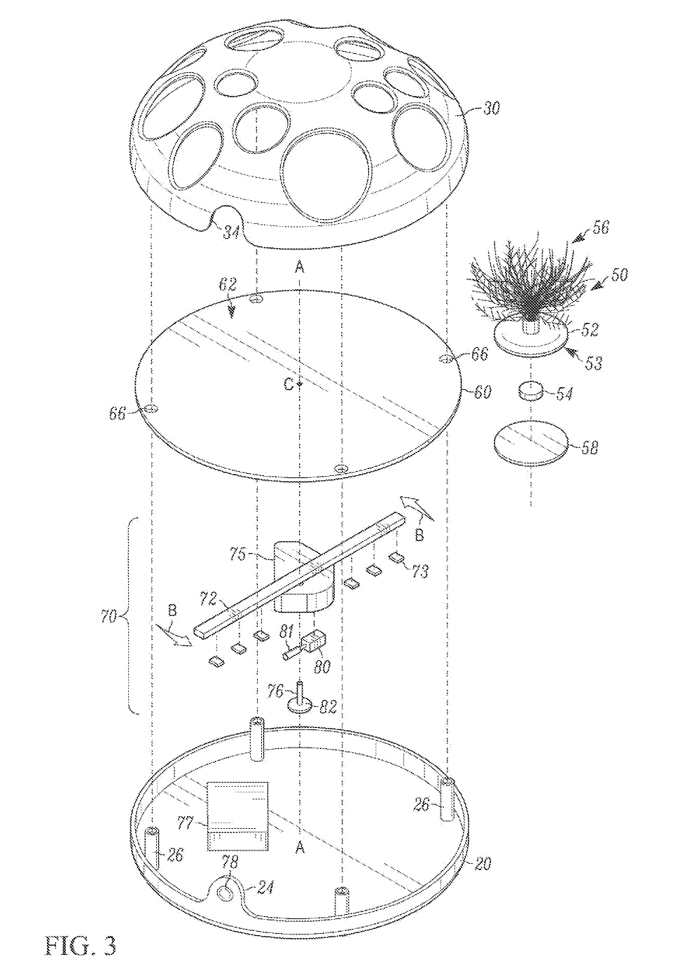

FIG. 3 illustrates an exploded view of pet amusement device 10 according to an aspect of the invention. Housing cover 30 may include a recess 34 formed therein for aligning with a correspondingly-shaped tab 24 on base member 20. Base member 20 supports a floor member 60 thereon and may include posts 26 that fit within holes 66 in floor member 60 to align base member 20 and floor member 60. Posts 26 may include apertures through which threaded fasteners may extend and engage threaded receptacles on housing cover 30 to secure the base member 20, floor member 60 and housing cover 30 together.

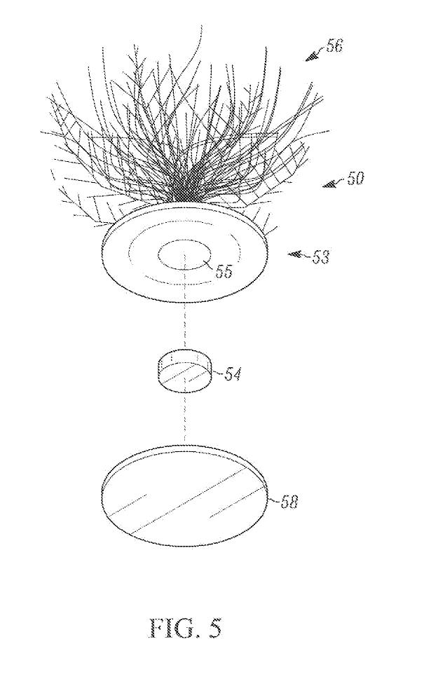

Play object 50 may include a generally disc-shaped base member 52 having a bottom surface 53 for housing a play object magnet 54, which may be disposed within a recess 55 (FIG. 5) formed in the underside of the base member 52 such that a bottom surface of the magnet 54 is flush with the base member bottom surface 53. A spacing disk 68 may be attached to the bottom surface 53 to maintain the play object magnet 54 an appropriate distance above the gilding surface 62 of the floor member 60. The play object 50 also may include one or more visually interesting elements 56, such as feathers, or other features of a prey animal, such as a mouse or bird, that may provide visually interesting motion and tactile interaction to the pet as the play object 50 moves.

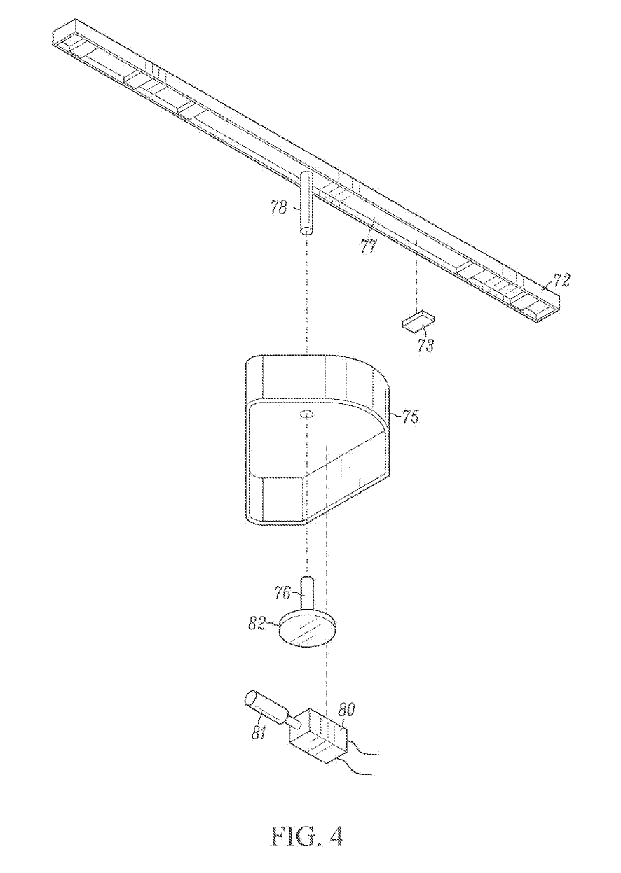

A play object driving assembly 70 may be disposed below the floor member 60 for causing the play object 50 to move on the gliding surface 62 in an unpredictable manner. Play object driving assembly 70 may include a carriage member 72, which is provided with one or more carriage member magnets 73, which may be secured within a recess 77 (FIG. 4), formed in the underside of carriage member 72. Carriage member 72 may be mounted on a rotating shaft 76 of a power transmission assembly 75, which may include an electric motor 80 having a spindle or worm gear 81 which engages a drive gear 82 having a shaft 76 which turns the carriage member 72 at an appropriate speed. Carriage member 72 may rotate in the direction of arrows ‘B’ about an axis “A” that is aligned with the center “C” of gliding surface 62. The power transmission assembly 70 may be mounted on a top surface of the housing base member 20. A power supply 77 may include batteries for providing the electrical energy to drive the electric motor 80. A switch 78 may be mounted on the alignment tab portion of base member 20 and be in electrical communication with power supply 71 and electric motor 80 to permit a user to turn the device on and off.

The orientation of carriage member magnets 73 and play member magnet 52 are preferably such that like poles are disposed towards one another so that a repelling force is applied to the play member magnet 52 by the carriage member magnets 73 when in proximity to the play object 50. Thus, as the carriage member 72 moves beneath the floor member 60, the play object will move in an unpredictable manner under the influence of the repelling magnetic forces created from the interaction of carriage member magnets 73 and play object magnet 52. Moreover, as the pet interacts in a tactile manner with the play object 50, the pet experiences tactile sensations, owing to the magnetic forces, which are more like those of a flying prey animal. Still further, the magnetic link between the play object driving assembly 70 and the play object 50 ensure that pet safety is not compromised, as would be the case with a direct mechanical linkage.

According to an aspect of the invention, the strength, number and spacing of carriage member magnets is selected such that no “dead zones” exist on the floor member 60. In other words, at all points on gliding surface 62, the play object magnet 52 will be subject to magnetic forces sufficient to move it laterally across gliding surface 62 as the carriage member 72 brings the carriage magnets to within proximity of the play object magnet 52.

Referring additionally to FIG. 4 motor 80 with a shaft having thereon a spindle or worm gear 81 may be mounted within a housing in such a manner as to engage drive gear 82 having a driveshaft 76 formed thereon. Drive that 76 may be attached to a carriage member drive shaft 78. Carriage member magnets 73 may be disposed within a recess channel 77 on the underside of carriage member 72, or may be disposed in individual recesses that are complementarily-shape, to the magnets 73 and secured therein with adhesive or other means.

Referring additionally to FIG. 5, play object magnet may be disk-shaped and disposed in a complementarily-shaped recess 55 formed in the underside of play object base 53. Spacing disk 58 may be attached to the underside of the play object base 53 using adhesive or other means, and operates to provide a low friction engagement with the gliding surface 62 as well as tot maintain play object magnet 54 at an appropriate distance above the gliding surface 62 and carriage member magnets 73 so as to ensure that the appropriate magnetic forces are applied to the play object 50 during rotation of the carriage member 72.

It should be understood that implementation of other variations and modifications of the invention in its various aspects may be readily apparent to those of ordinary skill in the art, and that the invention is not limited by the specific embodiments described herein. It is therefore contemplated to cover, by the present invention any and all modifications, variations or equivalents that fall within the spirit and scope of the claims that follow.

What is claimed is:

1. A pet amusement device comprising;
a housing defining an interior space;
a floor member disposed within the interior space and having, a gliding surface;
a play object supported on the gliding surface;
a play object drive assembly disposed within the housing and including a carriage member disposed proximate and the gliding surface and a motor for causing the carnage member to move, the play object including at least one carriage member magnet for magnetically engaging the play object and causing the play object to move on the gliding surface as the carriage member moves.

2. The pet amusement device of claim 1, further comprising a plurality of magnets on the carriage member, the carriage member magnets being positioned such that the play object is may be magnetically engaged by the magnets at substantially any place on the gliding surface.

3. The pet amusement device of claim 1, further comprising at least one play object magnet disposed on the play object.

4. The pet amusement device of claim 3, wherein the play object magnet is oriented with respect to the at least one carriage member magnet such that a repulsive force is provided on the play object by the at least one carriage member magnet.

5. The pet amusement device of claim 1, wherein the housing comprises a base member and a cover member, the cover member having a dome-shape and being provided with at least one aperture for providing the pet with intermittent visual and tactile interaction with the play object as the play object moves on the gliding surface.

6. The pet amusement device of claim 5, wherein the at least one aperture is sized to permit the pet to tactilely interact with the play object through the at least one aperture, and wherein the at least one aperture is sized to prevent removal of the play object from the interior space.

7. The pet amusement device of claim 1 wherein the carriage member is adapted to rotate about an axis that is substantially aligned with an axis of the gliding surface.

8. The pet amusement device of claim 1, wherein the play object includes a base, having a recess formed therein, and a play object magnet disposed within the recess.

9. The pet amusement device of claim 8, wherein the play object further comprises a spacing disk provided on the underside of the play object base and adapted to maintain the play object magnet a predetermined distance above the gliding surface.

10. The pet amusement device of claim 1, wherein the size of the play object is such that the play object cannot be removed form the interior space through the at least one aperture.
